(19) United States
(12) Patent Application Publication
(10) Pub. No.: US 2003/0054955 A1
(43) Pub. Date: Mar. 20, 2003

(54) Novel method for the preparation of supported bimetallic catalysts

(76) Inventor: Michael A. Loewenstein, Solon, OH (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 09/915,804

(22) Filed: Jul. 26, 2001

(51) Int. Cl. B01J 23/40

(52) U.S. Cl. 502/313; 502/326; 502/327

(57) ABSTRACT

One aspect of the present invention relates to a method of forming a bimetallic catalyst coating on a catalyst support. The method comprises forming an aqueous solution of compounds of the two metals. An alkanol amine is employed to facilitate formation of the solution and to prevent precipitation of the metals. The aqueous solution is applied to the catalyst support and dried, whereby the support develops a coating of bimetallic catalyst. The resulting catalyst can have exceptional characteristics in terms of uniformity of distribution between the two metals across the catalyst support. In the case of a porous support, the active components are deposited in a narrow band adjacent the outer surface, which is a desirable structure for PROX reaction catalysts.

### FIELD OF THE INVENTION

The present invention generally relates to catalysts. In particular, the present invention relates to supported bimetallic catalysts and methods of manufacturing them.

### BACKGROUND OF THE INVENTION

Fuel cells have many potential applications, including power plants for electrical vehicles. Fuel cells often use hydrogen as fuel. The hydrogen is supplied to the fuel cell's anode, which includes a catalyst. Oxygen (as in air) is supplied to the fuel cell's cathode.

Hydrogen for use in fuel cells can be derived from the reformation of methanol or other hydrocarbons. For example, in the methanol reformation process, methanol and water (as steam) react to generate hydrogen and carbon dioxide:

CH₃OH+H₂O⇄CO₂+3H₂

Typically, however, the reformation product contains an unacceptably high concentration of carbon monoxide. For example, the reformation product may contain 1-3% carbon monoxide. Carbon monoxide can quickly poison the catalyst of the fuel cell's anode, and accordingly must be removed. Generally, it is desirable to reduce the carbon monoxide concentration to 0.1 mole % or less.

The carbon monoxide level of the reformation product can be reduced by utilizing a water-gas shift reactor. In a water-gas shift reactor, water (in the form of steam) is added to the reformation product and the mixture is passed over a suitable catalyst. The water lowers the gas temperature and increase the steam to carbon ratio. The higher steam to carbon ratio drives the following reaction:

CO+H₂O⇄CO₂+H₂

Some CO remains after the shift reactor. Depending on such factors as the reformation product flow rate and the steam injection rate, the carbon monoxide content of the gas exiting the shift reactor can be about 0.5 mole %. Any residual methanol is converted to carbon monoxide and hydrogen in the shift reactor. Hence, the shift reactor effluent comprises hydrogen, carbon dioxide, water and some carbon monoxide.

Whether or not a water-gas shift reactor is employed, further removal of carbon monoxide is necessary, or at least desirable, in fuel cell applications. The CO content of H₂-rich gas is further reduced by a preferential oxidation reaction (“PROX”). The desired reaction is:

2CO+O₂⇄2CO₂

At the same time, it is desirable to minimize oxidation of hydrogen. Oxidation of hydrogen consumes fuel and generates waste heat that can be problematic. Oxidation is made selective by employing a suitable catalyst and controlling the oxygen concentration in the PROX reactor. The amount of oxygen employed is in excess of the stoichiometric amount required to react the CO present. Generally, about 2 times the stoichiometric amount is employed.

The catalyst in the PROX reactor generally includes platinum on a catalyst support. Frequently, the platinum is combined with another metal to form a bimetallic catalyst. An intimately mixed bimetallic catalyst can be resistant to CO poisoning, and therefore, can be used with comparatively high CO concentrations.

Many characteristics of supported metal catalysts affect the catalysis rate. Metal crystallite size, uniformity of composition, and distribution on the support all affect the degree of catalysis realized with a given amount of catalyst. There is an unsatisfied need for methods of forming bimetallic catalysts on catalyst supports in such a way as to provide more efficient utilization of the catalyst.

### SUMMARY OF THE INVENTION

The following presents a simplified summary of the invention in order to provide a basic understanding of some of its aspects. This summary is not an extensive overview of the invention and is intended neither to identify key or critical elements of the invention nor to delineate its scope. The primary purpose of this summary is to present some concepts of the invention in a simplified form as a prelude to the more detailed description that is presented later.

The present invention provides a method of forming a bimetallic catalyst coating on a catalyst support. According to the method, an aqueous solution containing compounds of the two metals is formed. An alkanol amine is employed to facilitate obtaining or maintaining the two metal compounds in solution. The aqueous solution is applied to the catalyst support and dried, whereby the support develops a coating of bimetallic catalyst. The resulting catalyst can have exceptional characteristics in terms of uniformity of distribution between the two metals across the catalyst support. In the case of a porous support, the active components can deposit in a narrow band adjacent the outer surface, which is a desirable structure for PROX reaction catalysts.

One aspect of the invention relates to a method of forming a bimetallic catalyst coating on a catalyst support. The method includes combining at least one compound of a first metal, which is a Group VIII metal, at least one compound of a second metal selected from the group consisting of Group VB, VIB, VIIB, VIII, and IB metals, an alkanol amine, and water to form an aqueous solution. The aqueous solution is contacted with the support, which is dried to obtain the support coated with a bimetallic catalyst.

Another aspect of the invention relates to an aqueous solution containing at least about 0.3% by weight of platinum in the form of a hydrous platinum oxide and at least about 0.03% by weight of iron in the form of an iron compound.

Yet another aspect of the invention relates to a bimetallic catalyst containing a first metal selected from the group consisting of Group VIII metals, a second metal selected from the group consisting of Group VB, VIB, VIIB, VIII, and IB metals, and a porous catalyst support on which the first and second metals are supported, wherein the metals exhibit peak concentrations within the porous support and the peaks are on average within about 50 μm of each other.

A still further aspect of the present invention relates to a bimetallic catalyst containing a first metal selected from the group consisting of Group VIII metals, a second metal selected from the group consisting of Group VB, VIB, VIIB, VIII, and IB metals, and a porous catalyst support on which the first and second metals are supported, wherein mean depths of deposition for the two metals are within about 25 μm of each other.

Other advantages and novel features of the invention will become apparent from the following detailed description of the invention and the accompanying drawings. The detailed description and drawings provide certain illustrative examples of the invention. These examples are indicative of but a few of the various ways in which the principles of the invention can be employed.

### BRIEF SUMMARY OF THE DRAWINGS

FIG. 1 is a high level schematic of a process according to one aspect of the present invention.

FIG. 2 is a schematic of an edge-coated particle.

FIG. 3 is a cross-section along line AA′ of FIG. 2.

FIG. 4 is graph showing the variation along a cross-section of a catalyst support of concentrations of platinum and iron in a catalyst coating formed by a method used prior to the present invention.

FIG. 5 is a graph similar to FIG. 4 but taken from a different sample.

FIG. 6 is another graph similar to FIG. 4 but taken from a different sample.

FIG. 7 is another graph similar to FIG. 4 but taken from a different sample.

FIG. 8 is another graph similar to FIG. 4 but taken from a different sample.

FIG. 9 is another graph similar to FIG. 4 but taken from a different sample.

FIG. 10 is graph showing the variation along a cross-section of a catalyst support of a concentrations of platinum and iron in a catalyst coating formed according to a method of the present invention.

FIG. 11 is a graph similar to FIG. 10 but taken from a different sample.

FIG. 12 is another graph similar to FIG. 10 but taken from a different sample.

FIG. 13 is another graph similar to FIG. 10 but taken from a different sample.

FIG. 14 is another graph similar to FIG. 10 but taken from a different sample.

FIG. 15 is another graph similar to FIG. 10 but taken from a different sample.

### DETAILED DESCRIPTION OF THE INVENTION

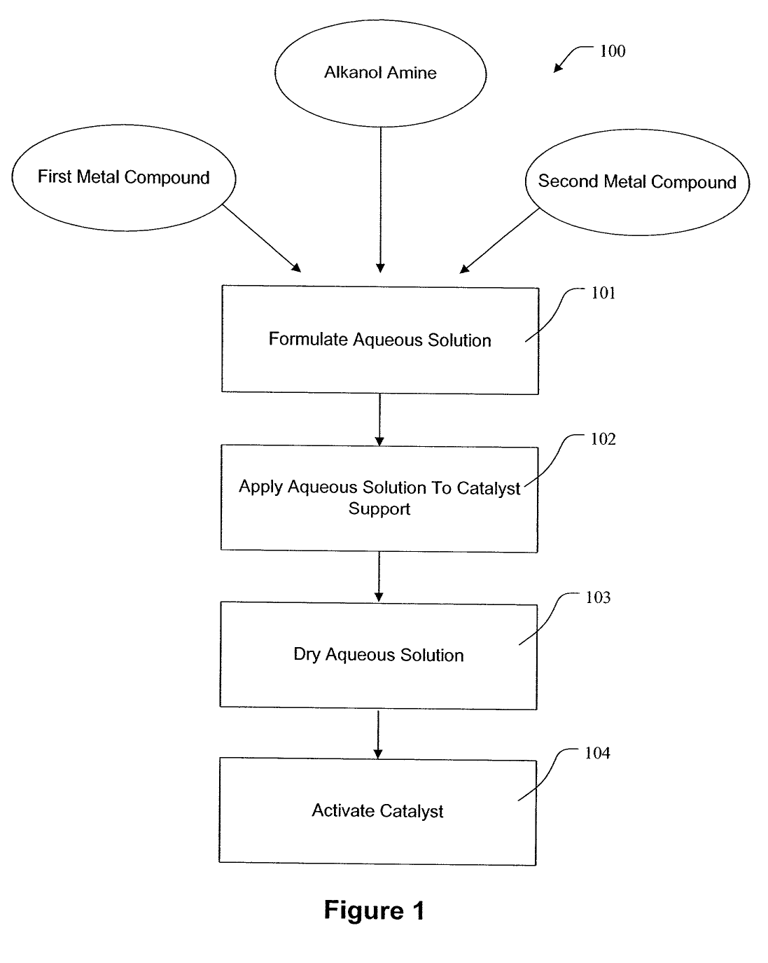

FIG. 1 provides a high level schematic of a process 100 for manufacturing a bimetallic catalyst according to one aspect of the present invention. Action 101 involves formulating an aqueous solution containing at least one compound of a first metal, at least one compound of a second metal, and an alkanol amine. Action 102 involves applying the solution to a catalyst support. Action 103 involves drying the catalyst, whereby a bimetallic coating, containing the first and second metals, is formed on the catalyst support. Action 104 provides for the activation of the catalyst.

The invention provides a catalyst including a porous catalyst support having a thin, uniform, bimetallic edge coating. As used in the present invention, the term bimetallic implies the presence of two metals, but does not exclude the presence of additional metals. The thinness of the edge coating and the uniformity of the distribution of the two metals within that coating is improved as compared to bimetallic coatings prepared by conventional methods.

In process 100 for forming the catalyst, the first metal compound is charged to an aqueous solution. The metal of the first metal compound subsequently becomes a component of the bimetallic coating formed on the catalyst support. The first metal compound is a compound of a Group VIII metal. Examples of Group VIII metals include platinum, iridium, nickel, palladium, rhodium and ruthenium. In many instances, the metal is one, such as platinum, that strongly adsorbs carbon monoxide. General examples of the first metal compound include Group VIII metal nitrates, Group VIII metal hydrates, Group VIII metal halogenates, Group VIII metal sulfites, Group VIII metal acetates, and other Group VIII metal salts.

Specific examples of first metal compounds include hydrogen hexahydroxyplatinum (IV), chloroplatinic acid, ammonium hexachloroplatinum (IV), bromoplatinic acid, platinum dichloride, platinum trichloride, platinum tetrachloride hydrate, tetraamine platinum chloride, tetraamine platinum nitrate, tetraamine platinum hydroxide, platinum dichloro-carbonyl dichloride, dinitrodiaminoplatinum, potassium hexachloroplatinum (IV), potassium tetrachloroplatinum (II), platinum nitrate, platinum sulfite, palladium chloride, palladium chloride dihydrate, and palladium nitrate. In one embodiment, the first metal compound is at least partially soluble in aqueous solution. In another embodiment, the first metal compound is at least partially soluble in aqueous alkaline solution (a solution having a pH greater than 7).

In one embodiment, the concentration of the first metal compound in the solution is from about 0.01 to about 10 weight percent. In another embodiment, the concentration of the first metal compound in the solution is from about 0.03 to about 3 weight percent. In a further embodiment, the concentration of the first metal compound in the solution is from about 0.1 to about 1 weight percent. Generally, the weight percent of the metal compounds is sufficiently low to permit dissolution of the metal compounds and provide a low viscosity solution. In a still further embodiment, the weight percent of the first metal compound is tailored to deliver an effective amount of catalyst when the solution is taken up and dried within the pore volume of a porous support.

The second metal compound is also charged to the aqueous solution and the second metal subsequently becomes a component of the catalyst coating along with the first metal. The second metal compound is a compound of a Group VB, VIB, VIIB, VIII, or IB metal. In embodiments where the second metal compound is a Group VIII metal compound, the metal of the second metal compound is different from the metal of the first metal compound. Examples of the second metal include, vanadium, chromium, rhenium, rhodium, ruthenium, iron, nickel, cobalt, silver, and gold. In some instances, the second metal compound promotes adsorption of oxygen and/or provides a source of oxygen. General examples of the second metal compound include Group VB, VIB, VIIB, VIII, and IB metal nitrates, Group VB, VIB, VIIB, VIII, and IB metal hydrates, Group VB, VIB, VIIB, VIII, and IB metal halogenates, Group VB, VIB, VIIB, VIII, and IB metal sulfites, VB, VIB, VIIB, VIII, and IB metal acetates, and other Group VB, VIB, VIIB, VIII, and IB metal salts. In one embodiment, the second metal compound is at least partially soluble in aqueous solution. In another embodiment, the second metal compound is at least partially soluble in aqueous alkaline solution. Specific examples of the second metal compound include ferric nitrate, ferric chloride, ferrous ammonium, ferric acetate, vanadium sulfate, chromic acid, chromium nitrate, rhenium pentachloride, perrhenic acid, ammonium perrhenate, rhodium trichloride, rhodium nitrate dihydrate, rhodium nitrate hexahydrate, ruthenium nitrate, ruthenium chloride, nickel nitrate, nickel chloride, cobalt chloride, cobalt nitrate, silver nitrate, and chloroauric acid.

In one embodiment, the concentration of the second metal compound in the solution is from about 0.001 to about 1 weight percent. In another embodiment, the concentration of the second metal compound in the solution is from about 0.03 to about 0.1 weight percent. In a further embodiment, the concentration of the first metal compound in the solution is from about 0.01 to about 0.1 weight percent. In a still further embodiment, the weight percent of the second metal compound is tailored to deliver, in combination with the first metal compound, an effective amount of bimetallic catalyst when the solution is taken up and dried within the pore volume of a porous support.

In one embodiment, the mole ratio between atoms of the first and second metals is from about 200:1 to about 1:10. In another embodiment, the mole ratio is from about 100:1 to about 1:3. In a further embodiment, the mole ratio is from about 50:1 to about 10:1. In many instances, the mole ratio promotes the formation of an effective bimetallic catalyst for a PROX reactor employed to remove carbon monoxide from a reformation product prior to introducing that product to a fuel cell.

The aqueous solution is further charged with one or more alkanol amines. The solution components can be charged in any order. The alkanol amine promotes the formation of a solution in which the first and second metal compounds, or complexes thereof, are in solution. The alkanol amine is itself at least partially water soluble.

The alkanol amine is characterized by the formula:

R(R)—N—R′—OH

wherein R′ is a divalent hydrocarbyl group of 1 to about 9 carbon atoms, and each R is independently hydrogen, a hydrocarbyl group of 1 to about 8 carbon atoms or an amino- or hydroxy-substituted hydrocarbyl group of 2 to about 8 carbon atoms. Thus, the alkanol amines may be monoamines or polyamines. The alkanol amine can also be a salt (quaternary ammonium) or an anhydride (ether) of a compound satisfying the foregoing formula. In a preferred embodiment, both R groups are hydrogen and thus the alkanol amine is a monoalkanol amine. Examples of alkanol amines include monoethanol amine, propanol amine, diethanol amine, N-methyl ethanol amine, dimethyl ethanol amine, morpholine, N-(2-hydroxyethyl) ethylene diamine, N,N-bis(2-hydroxyethyl) ethylene diamine, piperazine, 1-(2-hydroxyethyl) piperazine, monohydroxy-substituted diethylene triamine, dihydroxypropyl-substituted tetraethylene pentamine, N3-(3-hydroxybutyl) tetramethylene diamine, etc.

The term “hydrocarbyl” is used herein to include substantially hydrocarbyl groups as well as purely hydrocarbyl groups. The description of these groups as being substantially hydrocarbyl means that they contain no non-hydrocarbyl substituents or non-carbon atoms which significantly affect the hydrocarbyl characteristics or properties of such groups relevant to their uses as described herein. Examples of hydrocarbyl substituents which may be useful in connection with the present invention include alkyl, alkenyl, alicyclic and aromatic substituents.

In one embodiment, the concentration of the alkanol amine in the solution is from about 0.01 to about 10 weight percent. In another embodiment, the concentration of the alkanol amine in the solution is from about 0.03 to about 3 weight percent. In a further embodiment, the concentration of the alkanol amine compound in the solution is from about 0.1 to about 1 weight percent.

In a still further embodiment, the alkanol amine is present in the solution in a sufficient amount to provide a pH of at least about 8. In yet another embodiment, the concentration of the alkanol amine is sufficient provide a pH of at least about 9. In another embodiment, the concentration of the alkanol amine is sufficient provide a pH of at least about 9.5. In a still further embodiment, the concentration of the alkanol amine is sufficient to provide a pH of at least about 10. Where the concentration is characterized by the sufficiency of the alkanol amine to provide a particular pH, the pH is measured in the absence of solution components other than water, the first metal compound, the second metal compound, and the alkanol amine itself. Generally, the amount of the alkanol amine is at least sufficient for the alkanol amine to contribute to keeping substantially all of the first and the second metal compounds in solution.

A catalyst coating derived from the components of the aqueous solution is formed on a catalyst support. Any suitable catalyst support can be employed. The support can be porous or non-porous. It can have any suitable structure, including, for example, particulate or monolith structures. Particular structures include pellets and granules. Where the particles have regular shapes, they can be spheres, cylinders, cubes, pills, etc. In one embodiment, the particles have an average hydraulic diameter (defined as two thirds the particle volume divided by the particle external surface area) from about 1/64 to about 2 inches. In another embodiment, the particles have an average hydraulic diameter from about 1/16 to about ½ inch. In a further embodiment, the particles have an average a hydraulic diameter from about ⅛ to about ¼ inch.

The material of the support can be chemically inert, or where appropriate, chemically active. The support may contain a refractory oxide, a zeolite, and/or a molecular sieve. Suitable refractory oxides can include oxides of metals from Groups IIA, IIIA, IVB and IVA, including oxides of magnesium, aluminum, silicon, titanium, zirconium and/or thorium, for example. Refractory oxide supports can be crystalline, amorphous, or partially crystalline. Specific examples include alpha, delta, gamma and theta alumina (Al₂O₃), silicas, silicates, sodium borosilicate, MgO, CaO,Ca₂SiO₄, BaO, Ca₃SiO₅, ZrO₂, CeO₂, Cr₂O₃, La₂O₃, ThO₂, TiO₂, MgAl₂O4, MgCr₂O₄, ZnCr₂O₄, ZnAl₂O₄, CaSiO₃, SiO₂, SiO₂—Al₂O₃, clays such as bentonite, kaolin, and combinations thereof. Suitable materials also include activated carbons and carbon blacks, which can be in the form of powders, granules, spheres and extrudates

In one embodiment, the support is porous with individual particles (walls in the case of a monolith) having an average porosity from about 0.15 to about 1.5. In another embodiment, the support has a porosity from about 0.25 to about 0.7. In a further embodiment, the support has a surface area from about 1 to about 1,400 m²/gram. In a still further embodiment, the support is porous and has a surface area from about 5 to about 400 m²/g.

The solution can be contacted with the support by any suitable means. For example, the solution can be sprayed on the support or the support can be immersed in the solution. Where the support is porous, the solution can infiltrate the pores. In one embodiment, the support is porous and the volume of solution contacted with the support is at least about equal to half the pore volume of the support. In another embodiment, the support is porous and the volume of solution contacted with the support is about equal to the pore volume of the support.

After contacting the solution and the catalyst support, the solution is permitted to dry. Gentle heating (at temperatures below about 200° C.), dessication, or other technique may be employed to promote drying.

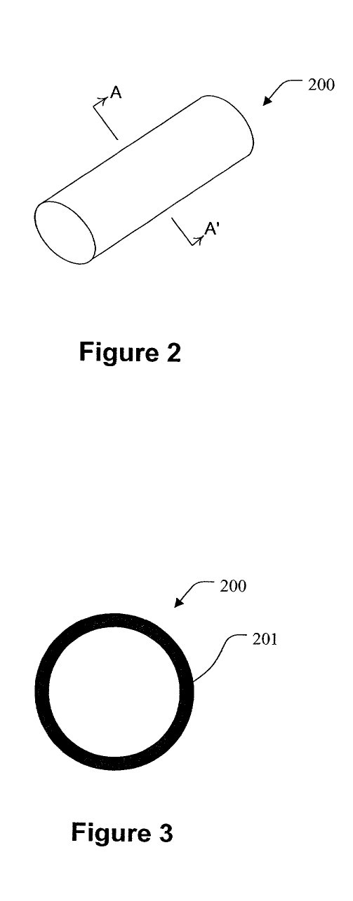

The solution dries and forms a bimetallic catalyst wherein the metals form a coating over the support. The coating need not cover the entire surface of the support and, in particular, need not completely coat the interior surfaces of pores within the support. In fact, in the case of a porous support, it can be desirable if the catalyst coating forms primarily at the edge of the support, near its outer surface. FIGS. 2 and 3 illustrate an edge coated particle 200. The catalyst coating 201 is concentrated near the outer surface of the particle 200.

In one embodiment, the concentration of the first metal in the catalyst is from about 0.01 to about 40 weight percent. In another embodiment, the concentration of the first metal in the catalyst is from about 0.03 to about 3 weight percent. In a further embodiment, the concentration of the first metal in the catalyst is from about 0.1 to about 1 weight percent. In a still further embodiment, the weight percent of the first metal in the catalyst is at least sufficient to provide an effective amount for a bimetallic catalyst.

In one embodiment, the concentration of the second metal in the catalyst is from about 0.001 to about 25 weight percent. In another embodiment, the concentration of the second metal in the catalyst is from about 0.003 to about 0.3 weight percent. In a further embodiment, the concentration of the second metal in the catalyst is from about 0.01 to about 0.1 weight percent. In a still further embodiment, the weight percent of the second metal in the catalyst is at least sufficient to provide an effective amount for a bimetallic catalyst.

In one embodiment, the support is porous and at least about 90% of the catalyst coating is supported in the outermost 50% of the pore volume. In another embodiment, the support is porous and at least about 90% of the catalyst is supported in the outermost 30% of the pore volume. In a further embodiment, the support is porous and at least about 90% of the catalyst is supported in the outermost 10% of the pore volume.

The first and second metals form a coating with a chemical form providing an active bimetallic catalyst. Within the coating, the first metal is generally in the form of a reduced metal. The first metal is often in a form that strongly adsorbs carbon monoxide. In one embodiment, in the finished catalyst, the first metal has an affinity for CO.

The second metal can also be in the form of a reduced metal. However, it is common for the second metal to form an oxide. In the finished catalyst, the second metal can be in a form that adsorbs oxygen and/or provides a source of oxygen. Generally, in the finished catalyst, the second metal is in either reduced or oxide form. In one embodiment, the second metal, under an atmosphere of methanol reformation reaction product gas with 0.5% oxygen added, supplies oxygen to adjacent metallic platinum at a rate about equal to or greater than that which ferric oxide supplies.

The two metals in the catalyst coating form an intimate mixture, whereby the two metals cooperate to provide an effective bimetallic catalyst. Accordingly, when the metals form particles, the particles are generally small. In many instances, the intimacy of the mixture permits differing molecules adsorbed respectively on the two metals to react together.

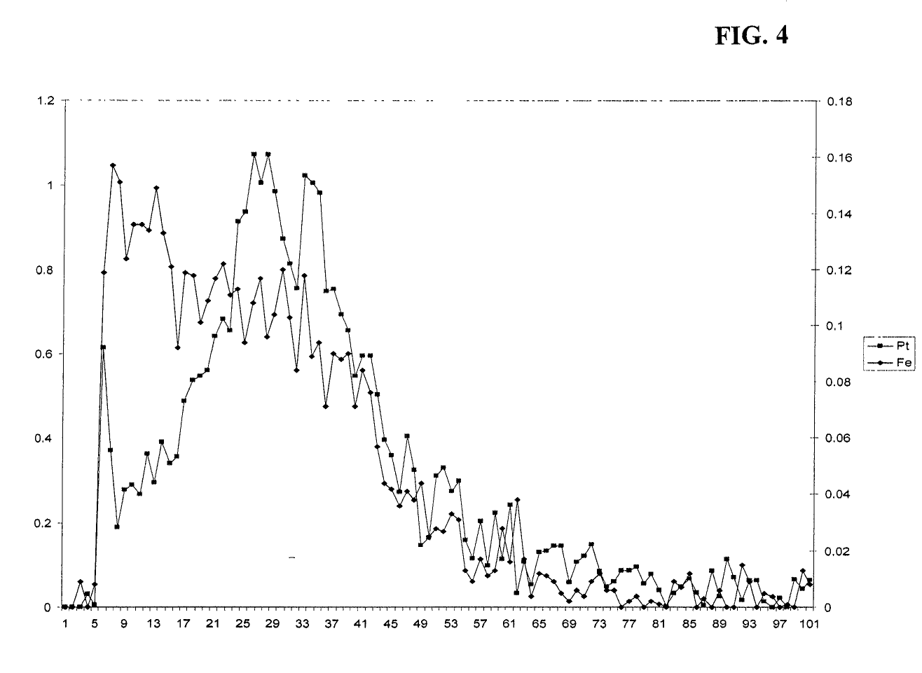

Process 100 provides a method of obtaining bimetallic catalysts in which the two metals are uniformly distributed within a porous support. FIG. 4 is an electron microprobe graph showing the distribution of iron and platinum through an interior cross-section of a porous catalyst pellet formed according to a method used prior to the present invention. The method used prior to the present invention did not employ an alkanol amine. The numbers across the bottom (horizontal axis) are 5 micron increments. The numbers across the side axes (verticle) are measurements of concentration for platinum and iron. Over the first five horizontal increments, the microprobe is probably not encountering the pellet. The low readings in this range are typical of noise present in the technique, as are the readings at the right most portion of the graph.

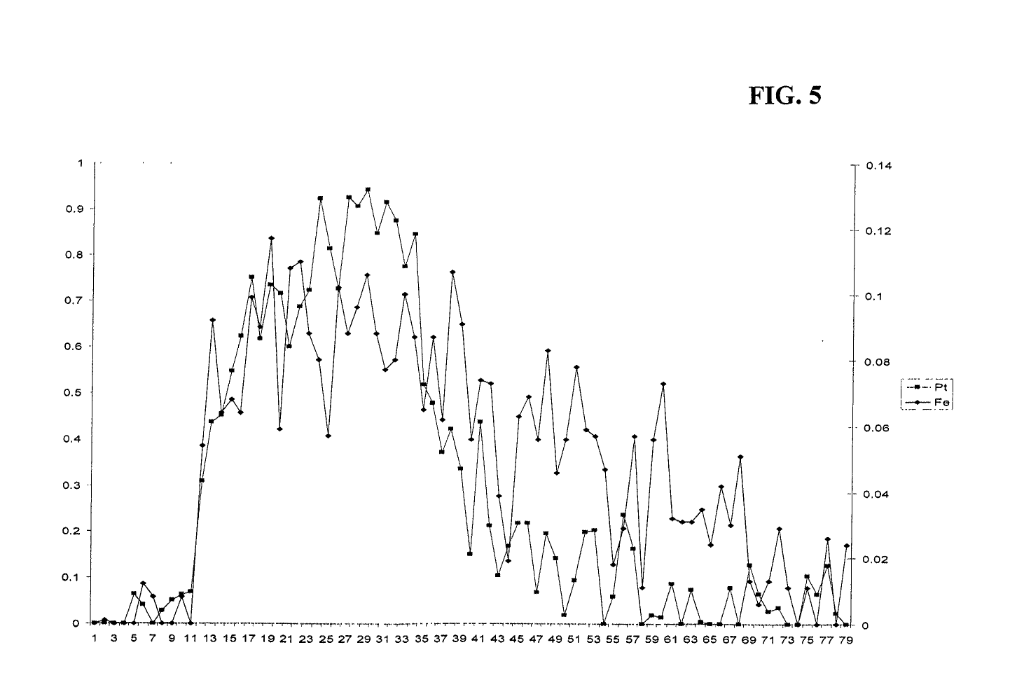

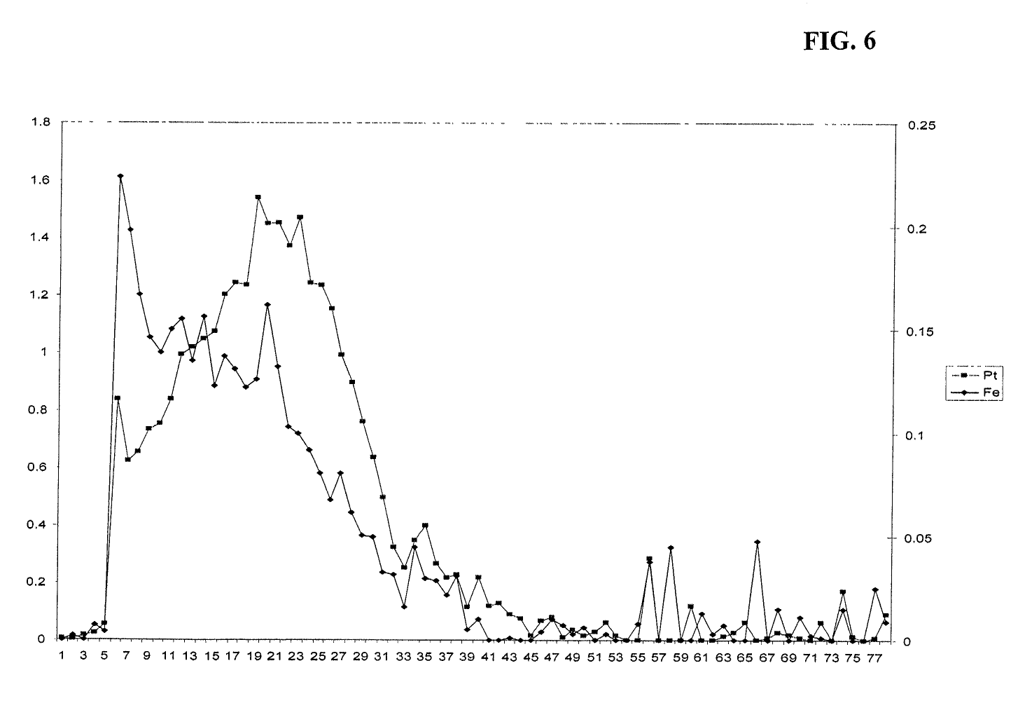

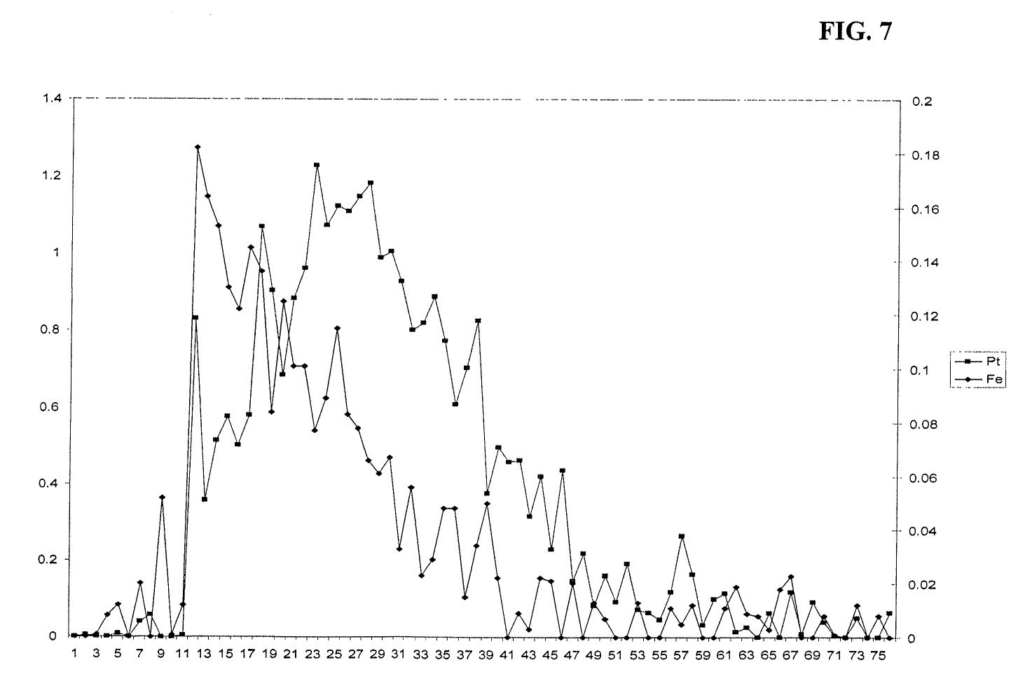

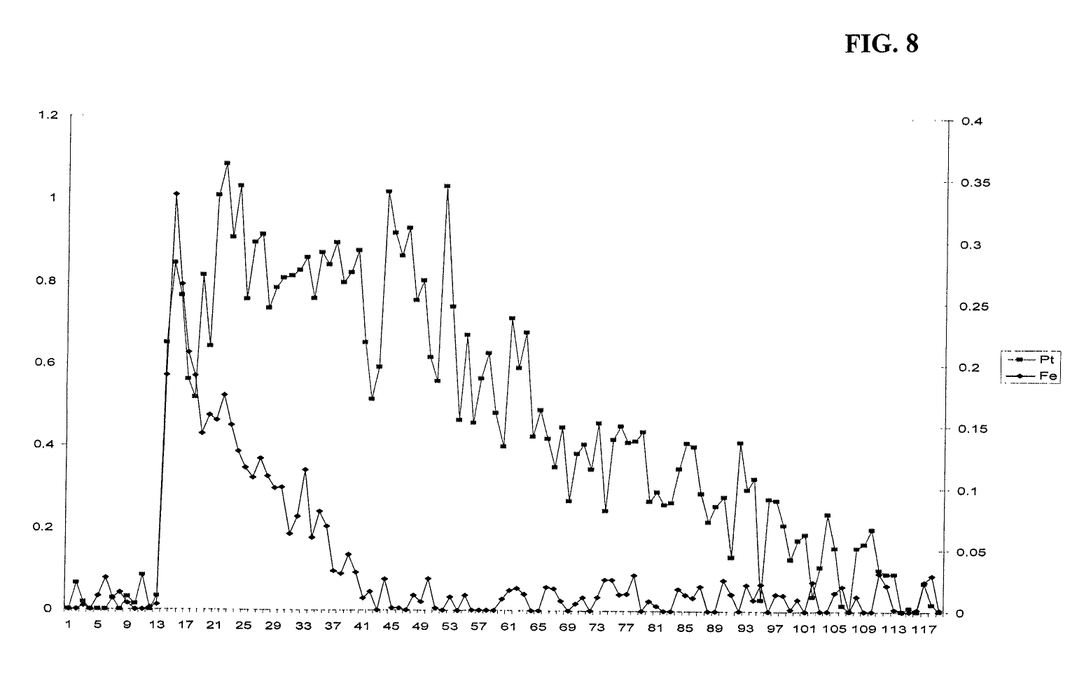

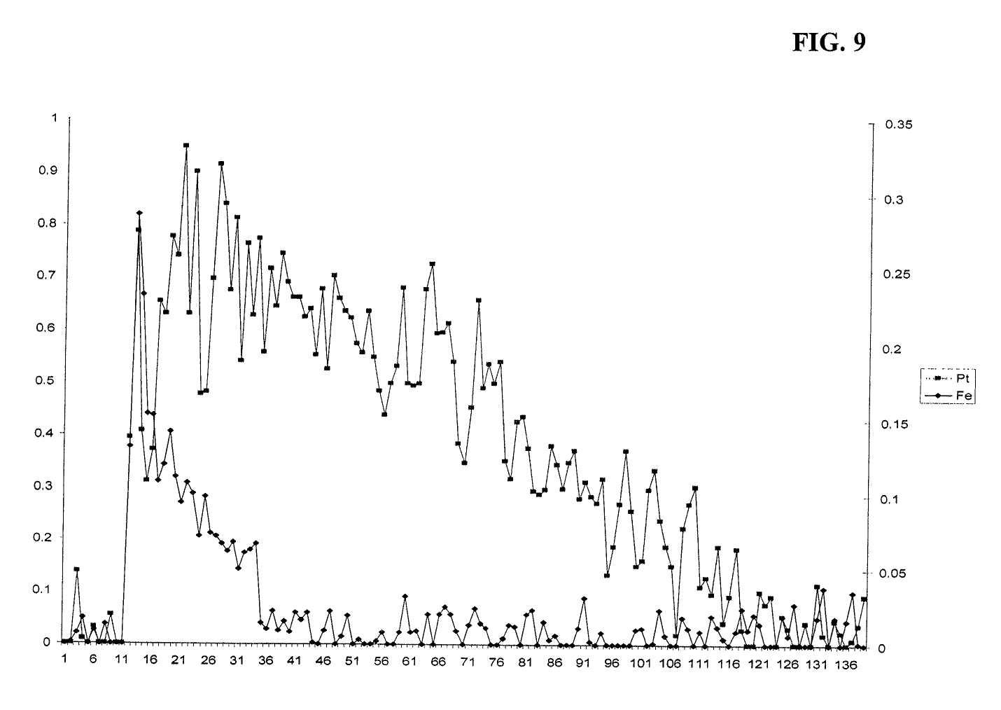

In FIG. 4, the peak concentration of iron occurs near the outer edge of the pellet (about 7 on the graph). The peak concentration of platinum, on the other hand, occurs over a 100 microns further into the pellet (about 28 on the graph). Similar results are shown in FIGS. 5 through 9, which are cross-sections from samples obtained by the same process as the sample of FIG. 4. The iron deposits nearer to the outer surface of the support than does the platinum

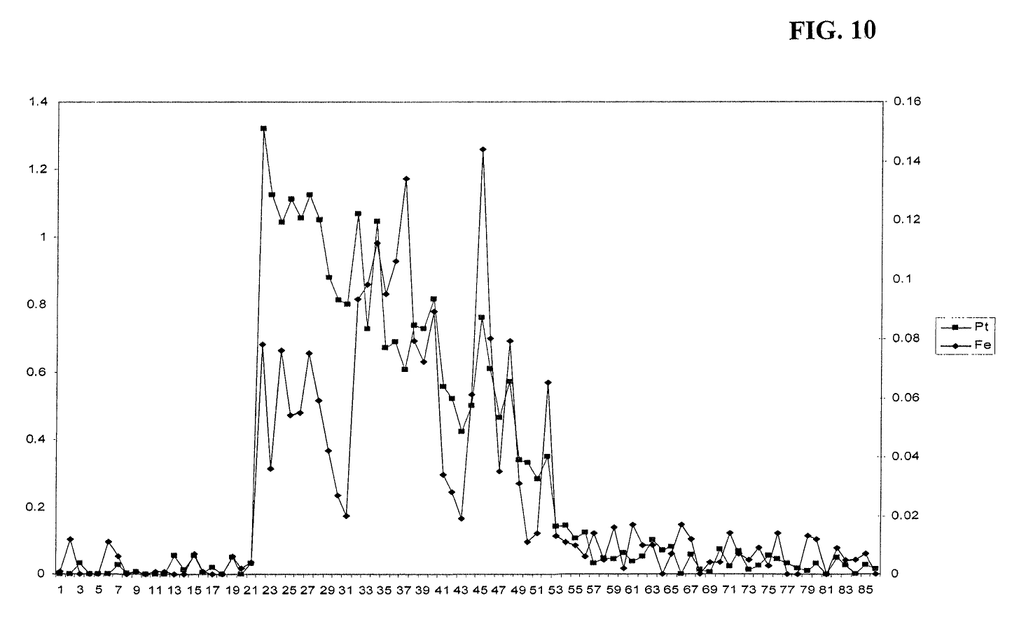

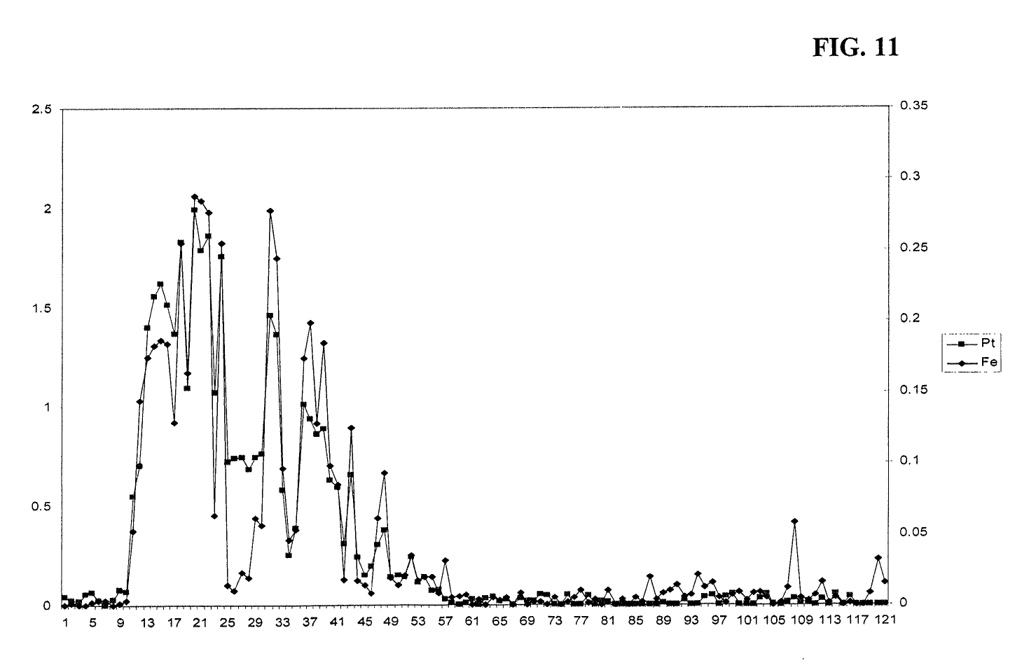

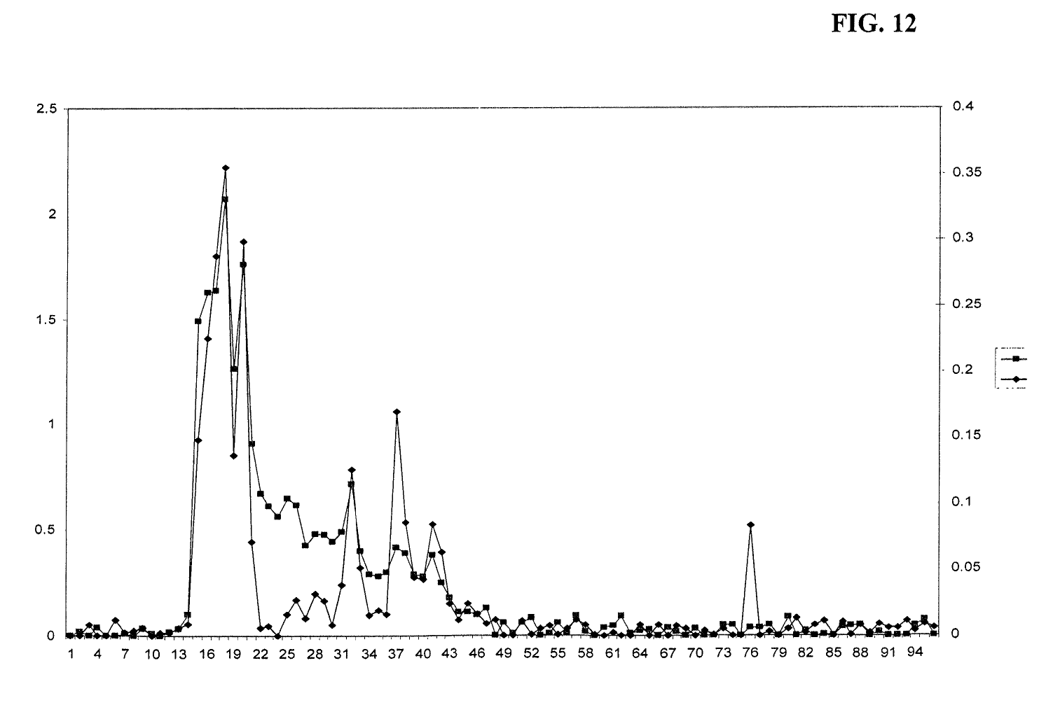

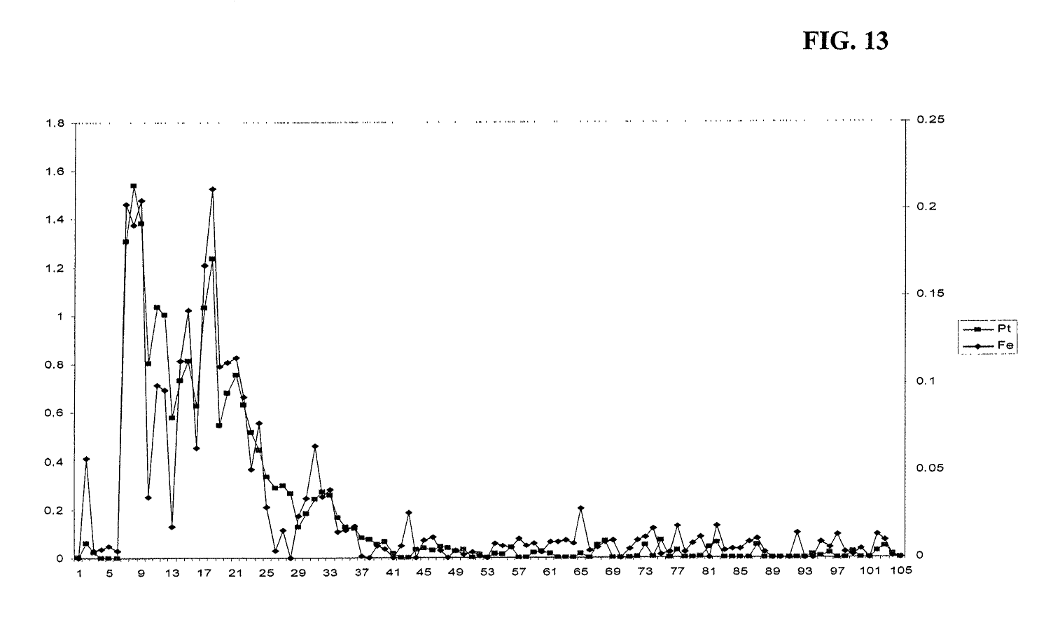

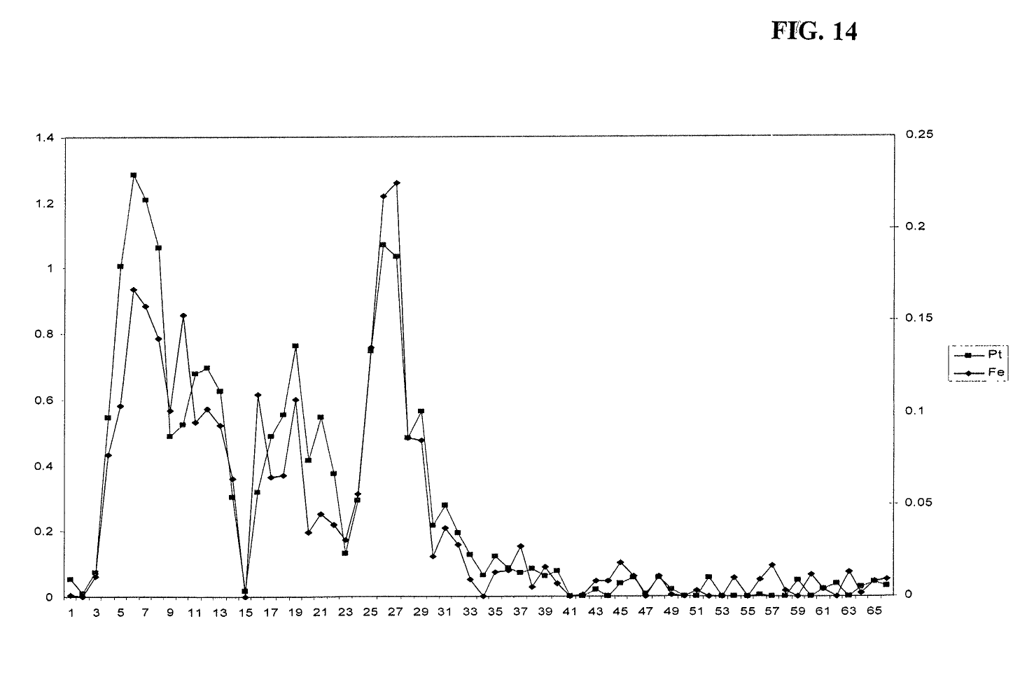

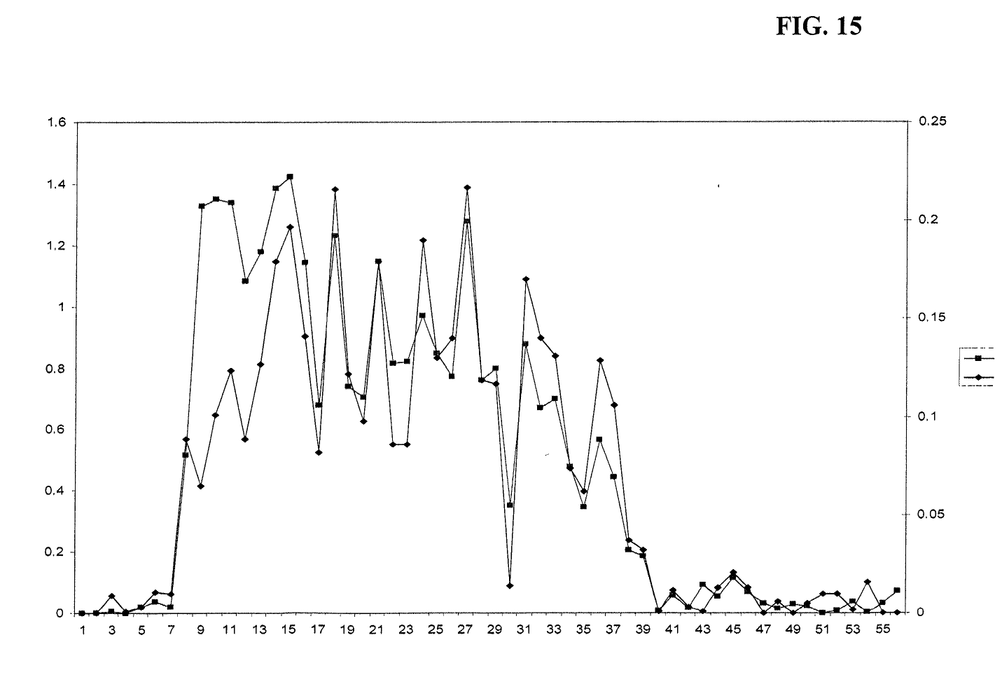

FIGS. 10 through 15 show the distributions of iron and platinum in pellets formed by a process according to the present invention, specifically, in accordance with Example 1, which is given below. These graphs show that the peaks and valleys of platinum and iron concentration in catalysts provided by the present invention are substantially coincident within the accuracy of the measurement.

As shown by the graphs, the width of the band over which the metals are distributed is narrower when the present invention is employed. In the samples produced according to the present invention, the band is from about 150 to about 250 microns wide. In the samples produced according to the previously employed process, the band is from about 250 to about 500 micron wide.

Table 1 compares the approximate peak locations of the two metals, measured relative to the particle edges for six sample cross-sections according to the present invention (A1-A6) and six sample cross-sections according to the previously used method (B1-B6). Sample A1-A6 correspond to FIGS. 10 to 15 and sample B1-B6 correspond to FIGS. 4 to 9. In the samples according to the present invention, the peak concentrations are generally coincident. In the samples according to the previously used method, the platinum peak occurs further into the support than the iron peak. As a result, the metals are not uniformly distributed in the catalyst made according to the previous used method, the mole ratios between the two metals show wide local variations, and the catalyst is less effective than the catalyst according to the present invention. Another advantage of the present invention is that the platinum is distributed within a tighter band near the surface of the support.

Accordingly, one embodiment of the present invention provides a bimetallic catalyst having a porous support in which the metals are co-distributed, whereby the peak concentrations of the two metals are on average within about 50 μm of each other. In another embodiment of the present invention, the peak concentrations of the two metals are on average within about 25 μm of each other. In a further embodiment of the present invention, the peak concentrations of the two metals are on average within about 10 μm of each other. A still further embodiment of the present invention provides a bimetallic iron/platinum catalyst on a porous support in which the peak platinum concentration occurs on average within about 50 μm of the support's outer surface.

TABLE 1
Comparison of concentration peak locations.

| Sample | Pt peak location | Fe peak location | Difference | Ratio (Pt/Fe) |
|---|---|---|---|---|
| A1 | 15 μm | 75 μm | (60 μm) | 0.2 |
| A2 | 45 | 45 | 0 | 1.0 |
| A3 | 20 | 20 | 0 | 1.0 |
| A4 | 15 | 15 | 0 | 1.0 |
| A5 | 15 | 15 | 0 | 1.0 |
| A6 | 50 | 50 | 0 | 1.0 |
| Average | 27 | 37 | (10) | 0.87 |
| B1 | 105 | 30 | 75 | 3.5 |
| B2 | 90 | 40 | 50 | 2.3 |
| B3 | 75 | 5 | 70 | 15.0 |
| B4 | 110 | 20 | 90 | 5.5 |
| B5 | 90 | 10 | 80 | 9.0 |
| B6 | 45 | 10 | 35 | 4.5 |
| Average | 86 | 23 | 68 | 5.8 |

The relative locations of the two metals within a cross section of the porous catalyst support can also be characterized by comparing their mean depths of deposition, Dₘ, for the two metals. Dₘ is given by the following equation:

$${D}_{m} = {\int }_{{V}^{*}} {rC}^{*} ⅆ {V}^{*}$$

Where r is distance from the pellet surface, C* is dimensionless concentration, and V* is dimensionless volume. Dimensionless volume is volume divided by the total volume of the pellet. Dimensionless concentration is given by concentration, C, divided by C₀, which is in turn given by:

$${C}_{0} = {\int }_{{V}^{*}} C ⅆ {V}^{*}$$

Table 2 compares estimates of the mean depths of depositions for the six samples according to the present invention (A1-A6) and the six samples produced by the previously used method (B1-B6). The same trends shown by the peak position data are again evident. The mean depths of deposition are closer together according to the present invention. In addition, the deposits are closer to the surface, particularly with respect to platinum.

Accordingly, in one embodiment, the mean depths of deposition for the two metals, averaged over the particles in a batch of porous catalyst particles, are within about 25 μm. In another embodiment, the mean depths of deposition are within about 10 μm. In a further embodiment, the mean depths of deposition are within about 5 μm. In a still further embodiment, the mean depth of deposition for the first metal is, on average, from about 5 μm to about 50 μm.

Catalysts of the present invention can also be characterized in terms of the ratio between mean depths of depositions for the two metals. In one embodiment, a ratio between the mean depths of deposition for the two metals, averaged over the particles in a batch of porous catalyst particles, is from about 0.75 to about 1.25. In another embodiment, the ratio is from bout 0.85 to about 1.15. In a further embodiment, the ratio is from about 0.9 to about 1.0.

The following examples illustrate the present invention. Unless otherwise indicated, in the examples or elsewhere in the specification and claims, all parts and percentages are by weight, all temperatures are in degrees Centigrade, and pressure is at or near atmospheric pressure.

TABLE 2
Comparison of mean depths of deposition.

| Sample | Dₘ for Pt | Dₘ for Fe | Difference | Ratio (Pt/Fe) |
|---|---|---|---|---|
| A1 | 63 μm | 74 μm | (11 μm) | .85 |
| A2 | 75 | 80 | (5) | .94 |
| A3 | 52 | 55 | (3) | .95 |
| A4 | 48 | 48 | 0 | 1.0 |
| A5 | 67 | 69 | (2) | .97 |
| A6 | 63 | 73 | (10) | .86 |
| Average (A1-A6) | 61 | 57 | (5) | .93 |
| B1 | 131 | 103 | 28 | 1.27 |
| B2 | 83 | 101 | (18) | .82 |
| B3 | 73 | 58 | 15 | 1.26 |
| B4 | 102 | 70 | 32 | 1.46 |
| B5 | 181 | 99 | 82 | 1.82 |
| B6 | 206 | 100 | 106 | 2.06 |
| Average (B1-B6) | 129 | 89 | 41 | 1.45 |

### EXAMPLE 1

0.217 g Fe(NO₃)₃×9H₂O (providing 0.03 g iron) is dissolved in 26 cc deionized water. 0.3 g Pt, in the form of H₂Pt(OH)₆, is dissolved in 8 cc deionized water with 2 moles of monoethanol amine per mole of platinum. The two solutions are combined and the mixture adjusted to pH 10 with monoethanol amine. The mixture is heated and maintained at 65 to 75° C. until a clear reddish solution is obtained. If necessary, the pH is readjusted to 10 with monoethanol amine. The solution is diluted with deionized water to obtain a volume of 35 cc. The solution is sprayed onto 99.7 g of ⅛ inch alumina tablets (cylinders) having a porosity of 0.35 cc/g. After aging 15 minutes, the tablets are dried.

The catalyst can be activated by heating at the rate of 5° C./min to 250° C. and maintaining the catalyst at that temperature for three hours under a flow of air. Alternatively, the catalyst can be activated with forming gas, which is 4-5% hydrogen in nitrogen. The gas is flowed over the catalyst at a rate of 55 cc/min as the catalyst is heated 5° C./min to 200° C. and maintained at that temperature for 2 hours.

### EXAMPLE 2

0.217 g Fe(NO₃)₃×9H₂O (providing 0.03 g iron) is dissolved in 26 cc deionized water. 0.3 g Pd, in the form of palladium chloride dihydrate, is dissolved in 8 cc deionized water with 2 moles of monoethanol amine per mole of platinum. The two solutions are combined and adjusted to pH 10 with monoethanol amine. The mixture is heated and maintained at 65 to 75° C. until a clear reddish solution is obtained. If necessary, the pH is readjusted to 10 with monoethanol amine. The solution is diluted with deionized water to obtain a volume of 35 cc. The solution is sprayed onto 100 g of ⅛ inch alumina tablets (cylinders) having a porosity of 0.35 cc/g. After aging 15 minutes, the tablets are dried.

### EXAMPLE 3

0.03 g of cobalt, in the form of cobalt nitrate, is dissolved in 26 cc deionized water. 0.3 g Pt, in the form of H₂Pt(OH)₆, is dissolved in 8 cc deionized water with 2 moles of monoethanol amine per mole of platinum. The two solutions are combined and adjusted to pH 10 with monoethanol amine. The mixture is heated and maintained at 65 to 75° C. until a clear solution is obtained. If necessary, the pH is readjusted to 10 with monoethanol amine. The solution is diluted with deionized water to obtain a volume of 35 cc. The solution is sprayed onto 100 g of ⅛ inch alumina tablets (cylinders) having a porosity of 0.35 cc/g. After aging 15 minutes, the tablets are dried.

### EXAMPLE 4

0.3 g iron, in the form of FeCl₃ hexahydrate, is dissolved in 26 cc deionized water. 0.3 g Pt, in the form of H₂Pt(OH)₆, is dissolved in 8 cc deionized water with 2 moles of monoethanol amine per mole of platinum. The two solutions are combined and adjusted to pH 10 with monoethanol amine. The mixture is heated and maintained at 65 to 75° C. until a clear solution is obtained. If necessary, the pH is readjusted to 10 with monoethanol amine. The solution is diluted with deionized water to obtain a volume of 35 cc. The solution is sprayed onto 100 g of ⅛ inch alumina tablets (cylinders) having a porosity of 0.35 cc/g. After aging 15 minutes, the tablets are dried.

### EXAMPLE 5

0.217 g Fe(NO₃)₃×9H₂O (providing 0.03 g iron) is dissolved in 26 cc deionized water. 0.3 g Pt, in the form of H₂Pt(OH)₆, is dissolved in 8 cc deionized water with 2 moles of morpholine per mole of platinum. The two solutions are combined and adjusted to pH 10 with morpholine. The mixture is heated and maintained at 65 to 75° C. until a clear reddish solution is obtained. If necessary, the pH is readjusted to 10 with morpholine. The solution is diluted with deionized water to obtain a volume of 35 cc. The solution is sprayed onto 100 g of ⅛ inch alumina tablets (cylinders) having a porosity of 0.35 cc/g. After aging 15 minutes, the tablets are dried.

### COMPARATIVE EXAMPLE 1

0.217 g Fe(NO₃)₃×9H₂O (providing 0.03 g iron) is dissolved in 26 cc deionized water. 0.3 g Pt, in the form of H₂Pt(OH)₆, is dissolved in 8 cc deionized water. The two solutions are combined and a precipitate is observed. The mixture is heated and maintained at 65 to 75° C., but the precipitate does not dissolve. The mixture is therefore unsuitable for forming a bimetallic catalyst coating.

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method of forming a bimetallic catalyst coating on a catalyst support, comprising:
combining:
at least one compound of a first metal selected from the group consisting of Group VIII metals;
at least one compound of a second metal selected from the group consisting of Group VB, VIB, VIIB, VIII, and IB metals;
an alkanol amine; and
water to form an aqueous solution;
contacting the aqueous solution with the support; and
drying the support to obtain a bimetallic catalyst coating on the support.

2. The method of claim 1, wherein the aqueous solution has a mole ratio between the first and second metals that is from about 100:1 to about 1:3.

3. The method of claim 1, wherein the first metal comprises platinum and the second metal comprises iron.

4. The method of claim 1, wherein the aqueous solution has a pH of at least about 9.

5. The method of claim 1, wherein the alkanol amine comprises a monoalkanol amine.

6. The method of claim 1, wherein the monoalkanol amine comprises monoethanol amine.

7. The method of claim 1, wherein the support is porous.

8. The method of claim 1, wherein the support comprises alumina.

9. The method of claim 1, wherein for at least about 90% of all cross-sections of the catalyst support, a mole ratio between the first and second metals is within a factor of two of a mole ratio between the first and second metals taken over the entire catalyst support.

10. The method of claim 1, wherein:
the support comprises particles of at least 1 mm in diameter;
within such particles, a mean depth of penetration for the first and second metals is at least about 20 microns; and
for at least 90% of all cross-section taken through the centers of such particles, the difference in the mean depth of penetration between the first and second metals is less than about 50 microns.

11. An aqueous solution, comprising:
at least about 0.3% by weight of platinum in the form of a hydrous platinum oxide; and
at least about 0.03% by weight of iron in the form of an iron compound.

12. The aqueous solution of claim 11, wherein the platinum compound is H₂Pt(OH)₆.

13. The aqueous solution of claim 11, wherein the iron compound is Fe(NO₃)₃9H₂O.

14. The aqueous solution of claim 11, further comprising an alkanol amine in a concentration sufficient to raise the pH to at least about 9.5.

15. The aqueous solution of claim 14, wherein the alkanol amine is a monoalkanol amine.

16. The aqueous solution of claim 15, wherein the monoalkanol amine is monoethanol amine.

17. A bimetallic catalyst, comprising:
a first metal selected from the group consisting of Group VIII metals;
a second metal selected from the group consisting of Group VB, VIB, VIIB, VIII, and IB metals; and
a porous catalyst support on which the first and second metals are supported;
wherein the metals exhibit peak concentrations within the porous support and the peaks are on average within about 50 μm of each other.

18. The bimetallic catalyst of claim 17, wherein the first metal comprises platinum.

19. The bimetallic catalyst of claim 18, wherein the second metal comprises iron.

20. The bimetallic catalyst of claim 19, wherein the porous support comprises alumina.

21. The bimetallic catalyst of claim 17, wherein the mole ratio between the first and second metals is from about 100:1 to about 1:3.

22. The bimetallic catalyst of claim 17, wherein the bimetallic catalyst comprises:
at least about 0.3% by weight of the first metal; and
at least about 0.03% by weight of the second metal.

23. The bimetallic catalyst of claim 22, wherein the bimetallic catalyst comprises:
at least about 0.3% by weight of platinum; and
at least about 0.03% by weight of iron.

24. The bimetallic catalyst of claim 17, wherein the concentration peaks by electron microprobe are within about 25 μm of each other.

25. A bimetallic catalyst, comprising:
a first metal selected from the group consisting of Group VIII metals;
a second metal selected from the group consisting of Group VB, VIB, VIIB, VIII, and IB metals; and
a porous catalyst support on which the first and second metals are supported;
wherein mean depths of deposition for the two metals are within about 25 μm of each other.

26. The bimetallic catalyst of claim 25, wherein the first metal comprises platinum.

27. The bimetallic catalyst of claim 26, wherein the second metal comprises iron.

28. The bimetallic catalyst of claim 27, wherein the porous support comprises alumina.

29. The bimetallic catalyst of claim 25, wherein the mole ratio between the first and second metals is from about 100:1 to about 1:3.

30. The bimetallic catalyst of claim 25, wherein the bimetallic catalyst comprises:
at least about 0.3% by weight of the first metal; and
at least about 0.03% by weight of the second metal.

31. The bimetallic catalyst of claim 30, wherein the bimetallic catalyst comprises:
at least about 0.3% by weight of platinum; and
at least about 0.03% by weight of iron.

32. The bimetallic catalyst of claim 25, wherein the mean depths of deposition are with about 10 μm of each other.

33. The bimetallic catalyst of claim 25, wherein:
the catalyst support comprises particles at least 1 mm in diameter and the mean depth of deposition for the first metal is, on average, from about 5 μm to about 50 μm.
